(19) United States
(12) Patent Application Publication
(10) Pub. No.: US 2024/0269776 A1
(43) Pub. Date: Aug. 15, 2024

(54) LASER ENGRAVING DEVICE FOR MULTIPLE LASER BEAMS USING A DATA LINK FOR ADJUSTING THE FOCUSING POSITION

(71) Applicant: ECOLE POLYTECHNIQUE FEDERALE DE LAUSANNE (EPFL), Lausanne (CH)

(72) Inventors: Luc BURNIER, Savigny (CH); Andreas SCHUELER, Lausanne (CH)

(73) Assignee: ECOLE POLYTECHNIQUE FEDERALE DE LAUSANNE (EPFL), Lausanne (CH)

(21) Appl. No.: 18/268,559

(22) PCT Filed: Dec. 21, 2020
(86) PCT No.: PCT/IB2020/062269

§ 371 Date: Jun. 20, 2023

(51) Int. Cl. B23K 26/362; B23K 26/06; B23K 26/067

(52) U.S. Cl. CPC B23K 26/362; B23K 26/0648; B23K 26/067

(57) ABSTRACT

The present invention concerns a laser engraving device for engraving a target surface. The laser engraving device comprises: a beam splitter for dividing a processing laser beam into a plurality of engraving laser beams; a first optical focusing element with an adjustable focal point for focusing the plurality of engraving laser beams onto the target surface; and an optical sensor configured to determine the distance between the target surface and the optical sensor. The first optical focusing element is connected to the optical sensor by a data link to receive the determined distance from the optical sensor. Furthermore, the first optical focusing element is configured to adjust its focal point based on the determined distance received from the optical sensor.

### TECHNICAL FIELD

The present invention relates to a laser engraving device for multiple laser beams for processing a target surface. The target surface may be for instance a non-patterned coating of a glazing unit installed on a train or in a building. By engraving the non-patterned coating by using the proposed device, a patterned coating can be obtained which would improve the penetration of electromagnetic waves through the coating in the radio frequency spectrum used for wireless communications.

### BACKGROUND OF THE INVENTION

In order to reduce energy consumption of for example trains and buildings, energy saving windows with better thermal properties are increasingly used. These energy saving windows are typically composed of two or more windowpanes. The thickness of the glass panes is selected to satisfy mechanical requirements of the glazing unit given by regulations. The gap between the glass panes suppresses acoustic noise, and it also improves thermal insulation. Energy saving windows typically comprise one or more coated glass panes. This coating has a low thermal emissivity and therefore reduces the heat transfer by radiation. It can also be a sun protection coating, reducing the transmission in the near infrared region. It is generally made of one to three layers of silver (Ag) along with some dielectric layers (zinc oxide (ZnO), silicon nitride (Si3N4), titanium dioxide (TiO2), etc.). Most trains and many modern buildings have a metallic structure, which when combined with the coating having one or more metallic layers on the windows, results in strong microwave attenuation inside the structure due to a Faraday cage effect. Electromagnetic (EM) waves used for telecommunications are thus strongly attenuated. This is problematic, as nowadays, wireless communications are increasingly used.

Solutions exist to perform a laser treatment on the electrically conductive coating to convert the coating to a frequency-selective surface (FSS). The FSS is a thin and repetitive surface designed to reflect, transmit or absorb electromagnetic fields. The FSS is able to make the coating, and thus the glazing unit substantially transparent to EM waves used in wireless telecommunications. The achieved effect is not limited to any specific frequency band, and the FSS makes it possible to achieve low attenuation for a large band of frequencies including the frequencies used in current wireless communication systems, such as global system for mobile communications (GSM), long-term evolution (LTE), multiple-input and multiple-output (MIMO), and future ones. However, the problem with the currently known laser treatment solutions is that they can only be applied at the production site, and the treatment can only be applied to a flat non-assembled glazing unit. This means that already installed energy saving glazing units, need to be replaced to benefit from the currently existing laser treatment solutions. This is a major limitation of the existing solutions.

It is also known to install repeaters in trains or buildings with poor indoor signal coverage. Repeaters consist of an antenna placed outside and another one placed inside, which is connected to an amplifier to increase the signal inside the train or building. This solution is technology-dependent, and a repeater works for a defined range of frequencies only. Since telecommunication standards evolve quickly, repeaters have to be often renewed (i.e., typically between 5 and 8 years). Furthermore, the repeater-based systems use a chipset and active components, which are prone to frequent failures. Moreover, repeaters have a high energy consumption. This reduces the energy savings achieved by modern windows.

Currently there is no reliable and well-functioning solution available to treat conductive coatings of glazing units that have been already installed in order to reduce their attenuation for EM waves used in telecommunications, and which would optionally improve their performance in terms of MIMO efficiency. More broadly, a reliable and well-functioning solution is needed to engrave or mark surfaces by using laser beam technology.

### SUMMARY OF THE INVENTION

It is an object of the present invention to overcome at least some of the problems identified above related to engraving surfaces. More specifically, one of the aims of the present invention is to provide a device that can be used to engrave an electrically conductive coating to generate a patterned or structured coating. Compared with non-patterned coatings, the patterned coating would reduce the attenuation for EM waves used in telecommunications, and it would have an improved performance.

According to a first aspect of the invention, there is provided a laser engraving device as recited in claim 1.

The invention allows laser processing of any surface having any shape. For instance, the device may be used to process an assembled glazing unit, which may have any number of windowpanes, and this with a high focus positioning accuracy. This is not achievable with currently known existing laser engraving systems using a mechanical, capacitive, inductive or optical distance sensor. In the present invention, fast tracking of the target surface is achieved using an optical sensor, which has a response time of 0.002 ms or even less, and a high-speed focusing element, such as a tunable lens. The device may be placed on a motion system, which would allow a high displacement speed (e.g. up to 10 m/s) of the device. It is to be noted that the speed of a standard engraving system using imaging and detection technology is often limited by the response time, which is typically between 20 ms and 100 ms.

Furthermore, as the proposed device comprises a focusing element, there is no need to move the entire device to follow the target surface, which would usually induce a speed limitation due to a mechanical moving part. Moreover, the proposed device has the advantage that the desired pattern can be generated rapidly thanks to the possibility of simultaneously using a plurality of engraving beams to engrave the target surface. More specifically, the use of multiple beams reduces drastically the time of processing. The processing time can thus be reduced by a factor 2 to 20 or even more depending on the number of engraving beams. Standard systems accept only one engraving beam due to the used distance detection or scanning systems.

If the proposed device is used to engrave a coating of a glazing unit, then the processed glazing unit would have the advantage that it has energy saving capabilities and it is transparent or substantially transparent to broadband EM frequencies including the ones used in telecommunications. Thus, the processed glazing unit shows a low attenuation for broadband microwave frequencies.

According to a second aspect of the invention, there is provided a laser engraving system comprising the laser engraving device according to the first aspect, and further comprising a motion system.

According to a third aspect of the invention, there is provided a method operating the laser engraving device according to the first aspect.

Other aspects of the invention are recited in the dependent claims attached hereto.

### BRIEF DESCRIPTION OF THE DRAWINGS

Other features and advantages of the invention will become apparent from the following description of a non-limiting example embodiments, with reference to the appended drawings, in which:

FIG. 1 is a simplified block diagram schematically illustrating the laser engraving device according to a first embodiment of the present invention;

FIG. 2 is a simplified block diagram schematically illustrating the laser engraving device according to a second embodiment of the present invention; and

FIGS. 3a to 3g illustrate different example coating patterns that may be obtained as a result of the engraving process.

### DETAILED DESCRIPTION OF EMBODIMENTS OF THE INVENTION

Some embodiments of the present invention will now be described in detail with reference to the attached figures. The embodiments are described in the context of a laser engraving device used to post-process an insulating glazing unit for a train wagon, but the teachings of the invention are not limited to this environment. For instance, the teachings of the present invention could be used in other applications or environments, such as in buildings. Identical or corresponding functional and structural elements which appear in the different drawings are assigned the same reference numerals. It is to be noted that the use of words “first”, “second” and “third”, etc. may not imply any kind of particular order or hierarchy unless this is explicitly or implicitly made clear in the context. Furthermore, the word “between” when used to give a numerical range also includes the end points of the range.

The following definitions may be used in the context of the present invention:
An insulating glazing unit (IGU) is understood to be an element comprising two or more windowpanes.
A windowpane can be made for example of borosilicate or soda lime (float) glass and/or polymer, such as polycarbonate, acrylic glass, polyethylene terephthalate or other transparent polymers or of laminate layers or sheets of at least the above-mentioned materials.
Lamination is a technique or process of manufacturing where a pane comprises multiple layers to form a pane so that the composite element achieves improved strength, stability, sound insulation, appearance, and/or other properties from the use of the differing materials. A laminate is a permanently assembled object created using, for example, heat, pressure, welding and/or gluing.
Telecommunication frequencies are considered frequencies in the region from 300 MHz to 70 GHz.
A gap in a glazing unit is the space between two adjacent panes of a glazing unit, and it can be filled with air, noble gases (e.g. argon) and/or vacuum, for example.
A coating is a covering or a layer of material that is applied to the surface of an object, also referred to as the substrate. In general, the purpose of applying a coating may be decorative, functional, or both. The coatings referred to in this text are typically functional. The coating itself may be an all-over coating, completely covering the substrate, or it may only cover a part or parts of the substrate.
Emissivity is the normalised value given to materials based on the ratio of heat emitted compared to a perfect black body, on a scale from zero to one. A black body would have an emissivity value of 1 and a perfect reflector would have an emissivity value of 0.
A low emissivity coating refers to a layer that emits low levels of thermal radiation (heat). Low emissivity coatings are usually made of multiple-layer coatings of dielectric and/or metallic thin films.
Wireless communication is the transfer of information between two or more points that are not connected by an electrical conductor, frequently over radio waves.
Incident angle is the angle between the direction of propagation of an electromagnetic wave incident on a surface and the line perpendicular to the surface at the point of incidence, called the normal.
Transmission loss in the context of the present invention describes the accumulated decrease in electrical power of a wave as it propagates through a certain area or through a certain type of structure.
Multiple input, multiple output, or MIMO, is a technique for a radio link using multiple transmission and receiving antennas.
Path loss imbalance in the context of the present invention is defined as the difference in transmission losses for different signal paths (e.g. different polarisations) of electromagnetic waves propagating through a medium.
Plane of incidence (also called the incidence plane) may be understood to be the plane which contains the surface normal and the propagation vector (or k-vector, or wavevector) of the incoming radiation. When reflection is specular, as it is for a mirror or other shiny surface, the reflected ray also lies in the plane of incidence. When refraction also occurs, the refracted ray lies in the same plane.
Polarisation is a property applying to transverse waves which specifies the geometrical orientation of the oscillations. An electromagnetic wave, such as light, consists of a coupled oscillating electric field and magnetic field, which are perpendicular. By convention, the polarisation of electromagnetic waves refers to the direction of the electric field. P-polarised waves are understood to have an electric field direction parallel to the plane of incidence on an object, and s-polarised waves have an electric field oriented perpendicular to that plane.

The main motivation behind the present invention was to propose a device that can be used to obtain an improved glazing design for windowpanes, especially in situations in which the glazing unit has already been placed in its final installation location. The windowpanes should not only satisfy mechanical and tension requirements, but they should also provide low attenuation for broadband frequencies and optionally an advantageous path loss imbalance, particularly between the s (perpendicular) and p (parallel) polarisations, for a wide range of angles of incidence and broadband frequencies used for wireless telecommunication. The insulating glazing unit or window is typically assembled from two or more windowpanes. Each windowpane may contain polymer, such as polycarbonate or acrylic glass, and/or glass. A structured or patterned coating with low thermal emissivity, i.e., an emissivity value below 20% or approximately 20% (usually named low-e coating), applied to one or more surfaces of the glazing unit generally results in low attenuation for broadband microwave frequencies and optionally also in a small path loss imbalance between parallel and perpendicular polarisations, which may improve MIMO efficiency.

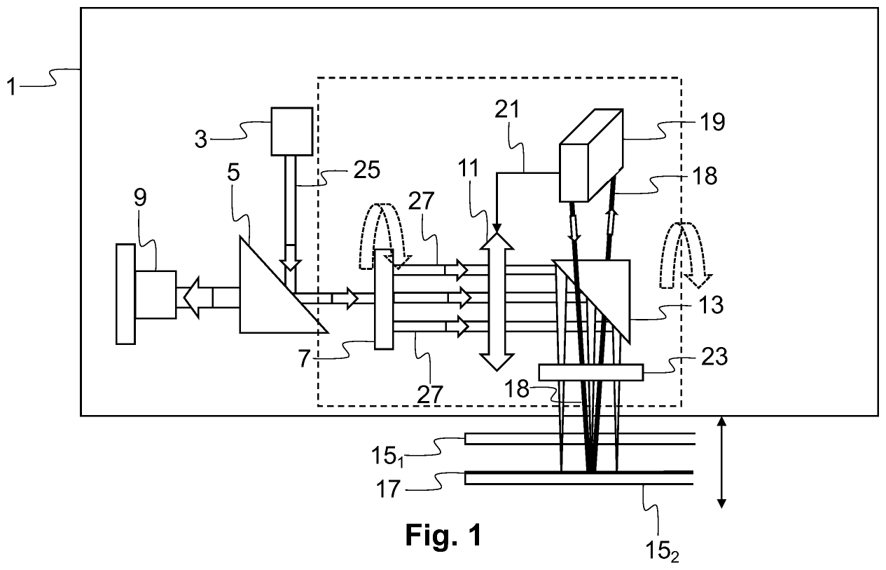

FIG. 1 schematically illustrates the laser engraving device 1, apparatus or optical auto-focusing system for multiple laser beam processing, also referred to as a laser head, according to the first embodiment of the present invention. A laser source 3 or isolator, which may or may not be part of the laser head 1, is provided to generate a light or laser beam, also referred to as a processing laser beam or working laser beam 25, that is directed to a first mirror, which in this case is a dichroic mirror 5, also known as a dichroic filter. The laser source (where the letters in the word stand for “Light Amplification by Stimulated Emission of Radiation” is configured to produce a very narrow beam of light. In the produced narrow beam of light all of the light waves have very similar wavelengths. The laser's light waves travel together with their peaks all lined up, or in phase. This is why laser beams are very narrow, very bright, and can be focused into a very tiny spot. A dichroic mirror is a thin-film filter or interference filter, which operates as a very accurate colour filter used to selectively pass light of a small range of colours while reflecting other colours. In other words, the dichroic mirror 5 is configured to reflect the incoming laser beam from the laser source towards a beam splitter 7, beam multiplier or beam divider, while it allows a visible light beam reflected from the target surface to pass through it towards an optional vision system 9, which the user or technician may use to visually inspect the progress or quality of the engraving process.

The beam splitter 7 is an optical device that is configured to split a beam of light in two or more beams of light. In this specific example, the beam splitter is a diffractive beam splitter, also known as a multi-spot beam generator or an array beam generator, which is a single optical element that divides an input beam into N output beams. Each output beam retains the same optical characteristics as the input beam, such as size, polarisation and phase. A diffractive beam splitter can generate either a 1-dimensional beam array (1×N) or a 2-dimensional beam matrix (M×N), depending on the diffractive pattern on the optical element. The diffractive beam splitter is used with monochromatic light such as a laser beam, and is designed for a specific wavelength and angle of separation between output beams. In the present example, the number of generated beams is between 2 and 20, or it could more specifically be between 6 and 20. These output beams are in the following text also referred to as engraving beams 27.

The laser head 1 further comprises a first optical focusing element 11 in the path of the beams coming from the beam splitter 7. The first focusing element is used to adjust the focal point of the laser beams that travel through it to minimise defocus aberration. The focusing element may comprise a lens, such as a mechanically movable lens, or alternatively, a tunable lens, also called a liquid lens, may be used. In the configuration of FIG. 1, the laser head 1 also comprises a second mirror 13, which may be a state-of-the art mirror to redirect the incoming engraving laser beams towards the target surface.

In the example of FIG. 1, the glazing unit comprises two windowpanes, namely a first windowpane 15₁ and a second windowpane 15₂. However, the glazing unit could comprise any number of panes. These windowpanes are arranged in this example so that the engraving beams first traverse the first windowpane 15₁ before reaching the second windowpane 15₂. In this specific configuration, the coating 17 to be engraved, and which thus also has the target surface, is placed on the inner surface of the second windowpane. In other words, the exposed surface of the coating is facing the gap between the first and second windowpanes. However, it is to be noted that the coating to be engraved could be placed on any surface of any one of the windowpanes, and the proposed laser head 1 would be able to engrave it. The gap may be filled with gas, such as air or argon, to improve the thermal and/or acoustic noise insulating properties of the glazing unit. The windowpanes are typically laminated elements. More specifically, they comprise at least two layers attached, bonded, fixed or glued together, but they may be one-layer panes instead. For example, a polymer layer is often sandwiched and bonded between two glass layers. The double ended arrow next to the windowpanes in FIG. 1 indicates the focusing range of the first optical focusing element 11.

As is further shown in FIG. 1, the laser head 1 also comprises a distance measurement device or distance sensor 19, which in this example is an optical sensor, or more specifically an optical distance sensor. The optical distance sensor is configured to measure the distance between the optical distance sensor and the target surface 17 by emitting a measurement beam or light 18 and by detecting the position of the reflected beam or light on the target surface 17. In this manner, the distance between the optical distance sensor and any of the reflecting surfaces may be detected. More specifically, the distance measurement is based on the triangulation principle. The measurement (laser) beam strikes the target surface as a small point. The receiver of the sensor (photodiode line) detects the position of this point. The angle of incidence changes according to the distance, and thereby the position of the laser point on the receiver. The photodiode line is read by an integrated microcontroller. The controller accurately calculates the angle from the light distribution on the photodiode line and then calculates the distance to the object from this. This distance is either issued at the serial port or converted into an output current proportional to the distance. The microcontroller guarantees a high degree of linearity and measuring precision. However, instead of using an optical distance sensor, an optical displacement sensor can be used for this application. The principle of laser displacement sensor ranging is a method where triangulation is applied by combining the emitting element and the position sensitive device (PSD) of the laser displacement sensor to perform ranging (detecting the amount of displacement). As is shown in FIG. 1, the distance sensor 19 is connected to the first optical focusing element 11 by a data link 21, which may be wire data connection, such as an electrical conductor, or a wireless data connection.

The laser head 1 optionally also comprises a second optical focusing element 23, which in this example is a fisheye lens, and more specifically an f-theta lens, also known as a flat lens or a scanning lens, which is a type of fisheye lens. The f-theta lenses are designed to produce a focused spot in a flat field, the position of the spot being proportional to the focal length (f) of the lens and the angle (theta) of the beam entering the lens, giving them the name f-theta lenses. Ideally the size of the focused spot is constant throughout the field. As shown in FIG. 1, in the present configuration, the optional f-theta lens 23 is placed in the path of the engraving beams 27 to focus the different beams in the same plane (instead of them being focused on a sphere). Of the elements described above, the second optical focusing element 23 is the element closest to the coating to be engraved.

The laser head 1 may be placed on a motion system (not illustrated in the drawings), such as a robotic arm, that may be configured to rotate around any number of rotation axes, such as around three orthogonally arranged rotation axes. Furthermore, the motion system may be configured to translate the laser head 1 in any desired direction, optionally to move the laser linearly in the desired direction. Optionally, the beam splitter 7 is also arranged to rotate around one or more rotation axes. In this example, the beam splitter is arranged to rotate around a rotation axis, which is parallel or substantially parallel to the direction of the processing laser beam 25 entering the beam splitter 7. Optionally, a sub-entity formed by the beam splitter 7, the first optical focusing element 11, the second mirror 13, and the second optical focusing element 23 is also arranged to rotate around one or more rotation axes. In this example, the sub-entity is arranged to rotate around a rotation axis, which is parallel or substantially parallel to the direction of the engraving beams 27 traversing the first optical focusing element 11. In other words, the rotation axis of the beam splitter 7 would in this case coincide with the rotation axis of the sub-entity.

The operation of the laser head 1 is next explained in more detail. The laser head 1 is first placed in its desired start position and then the processing laser beam 25 is generated and directed to the dichroic mirror 5. The processing beam is reflected by the dichroic mirror 5 towards the beam splitter 7, which divides the processing beam into a given number of parallel engraving beams 27 or divided processing beams. The engraving beams 27 then propagate through the first optical focusing element 11 which dynamically adjusts its focal point based on the distance information received from the distance sensor 19. In this manner the engraving beams can be precisely focused on the target surface 17. To achieve this, the distance sensor 19 repeatedly, i.e., at given time intervals tracks the distance between the distance sensor and the target surface, which in this case is the surface of the coating 17. It is to be noted that the term “time interval” does not necessarily have to be a constant time interval, i.e. a constant time period, but it may instead be a non-constant time interval. In other words, the word “repeatedly” in the present description is understood to mean taking a given action a plurality of times, or “again and again” at regular or irregular time intervals. The distance sensor may receive as an initial input e.g. from the user of the laser head the position of the coating within the glazing unit, i.e., at which interface the coating is placed. Alternatively, the distance sensor determines the location of the coating by analysing the reflected wavelengths from the different interfaces of the glazing unit. In this example, the response time of the distance sensor 19 is between 0.5 us and 20 μs, or more specifically between 0.5 us and 10 μs, or between 1 us and 3 μs. The response time thus indicates how often the distance measurements can be taken and how often the distance information can be updated. The propagating engraving laser beams 27 are directed by the second mirror 13 towards the coating 17. Before the engraving laser beams reach the target surface, they propagate through the second optical focusing element 23, which refocuses the engraving beams so that they are all focused on one plane (i.e. the surface of the coating 17).

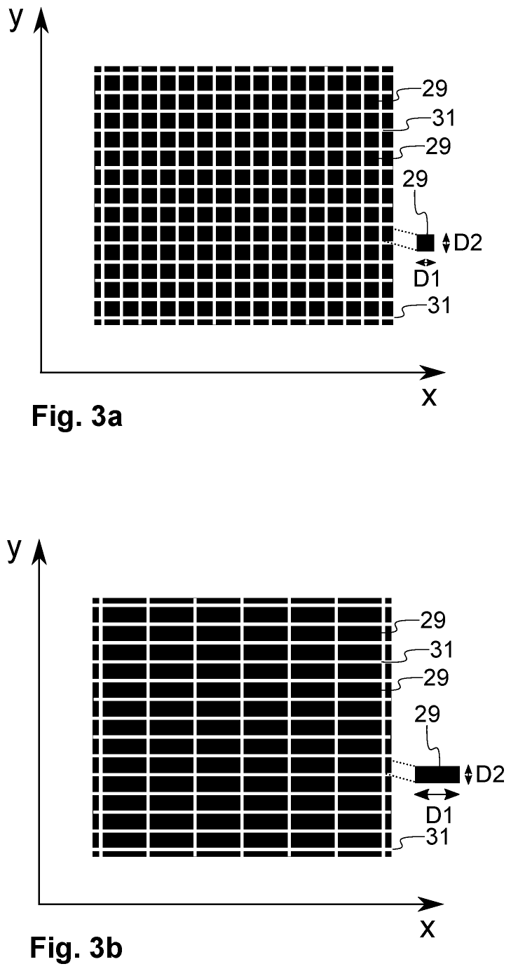

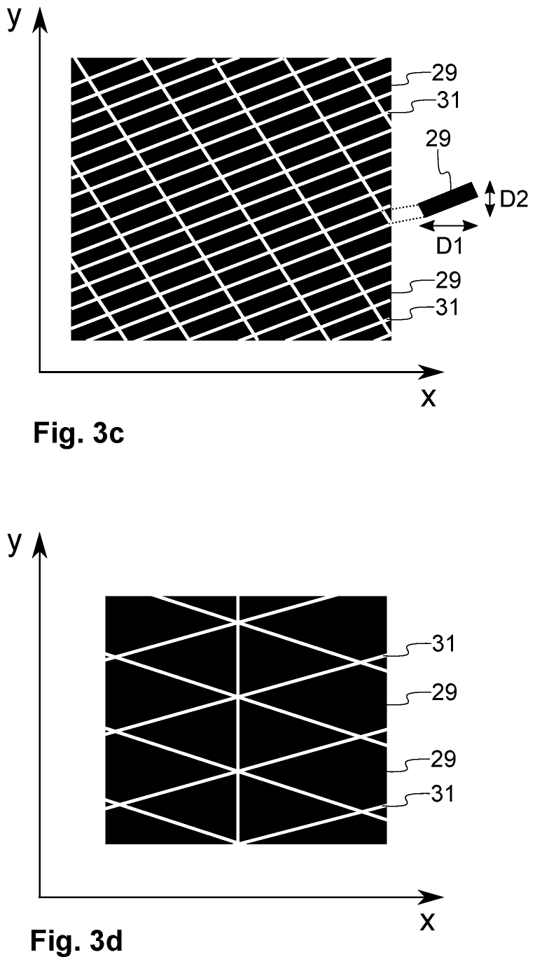

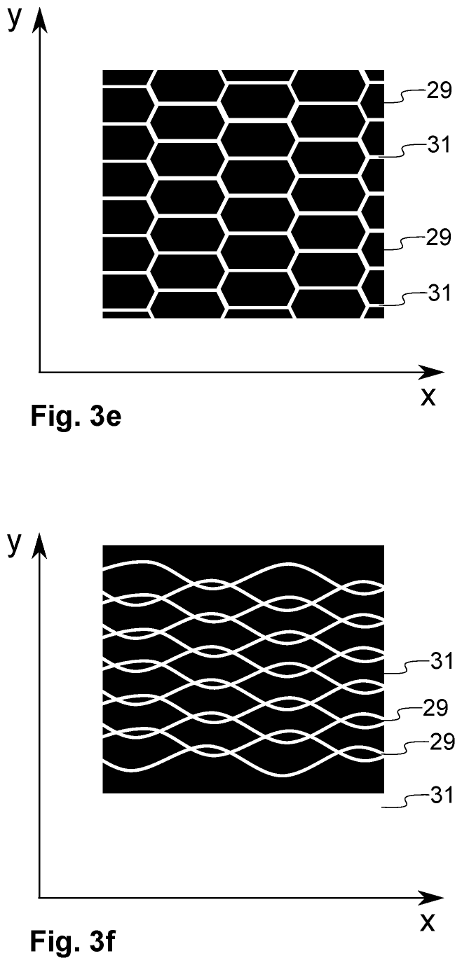

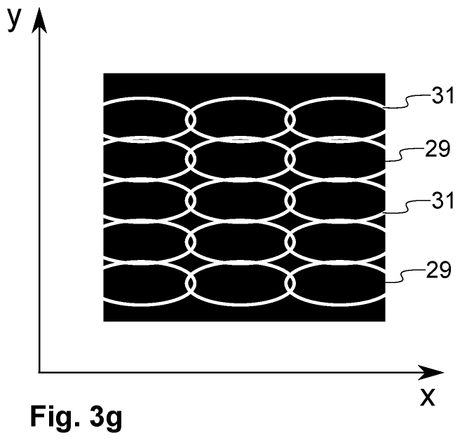

As mentioned above, the distance sensor 19 is arranged to communicate with the first optical focusing element 11 at given time intervals. These time intervals may be the same as the ones used for taking distance measurements. The first optical focusing element 11 then repeatedly adjusts its focal point depending on the received distance information. More specifically, if the distance sensor detects that the distance increases to the coating 17, then also the focal point of the first focusing element is moved further away from the laser head, or vice versa. In this manner, the focal point follows the surface of the coating. Here again the adjustment time intervals may be the same as the distance measurement time intervals. However, this does not have to be the case. It is to be noted that during the above engraving process, the laser head 1 moves along a pre-programmed path to generate the desired pattern on the coating 17. More specifically, thanks to the engraving process, the desired pattern of electrically conductive patches 29 (as shown in FIGS. 3a to 3g), which are electrically insulated from each other, can be generated to minimise the attenuation.

Visible light gets then reflected from the coating 17. This light is then reflected by the second mirror 13 towards the dichroic mirror 5, which allows the light to pass through it to reach the vision system 9, such as a camera. The vision system 9 is aligned with the path of the incoming light beam and thus the technician can visually monitor the engraving process. Alternatively, or in addition, the vision system 9 may comprise an image recognition software tool to implement a computer-implemented monitoring framework of the engraving process.

The end result of the engraving process is thus a patterned coating, which advantageously has low thermal emissivity (a low-e coating). The coating may, for example, comprise a metal layer, such as a silver layer (to make it a silver-based coating), sandwiched between two oxide or dielectric layers, which may be any one of the following layers: zinc oxide (ZnO), silicon nitride (Si3N4), and titanium dioxide (TiO2) layers. The coating may be deposited onto a desired surface by applying sputter deposition, which is a physical vapour deposition (PVD) method of thin film deposition by sputtering. Alternatively, the coating may be a pyrolytic coating, which is a thin film coating applied at high temperatures and sprayed onto a glass surface, during the float glass process. The cross-sectional thickness of the transparent coating may be between 10 nm and 1000 nm, or more specifically between 50 nm and 300 nm, or more specifically between 100 nm and 200 nm.

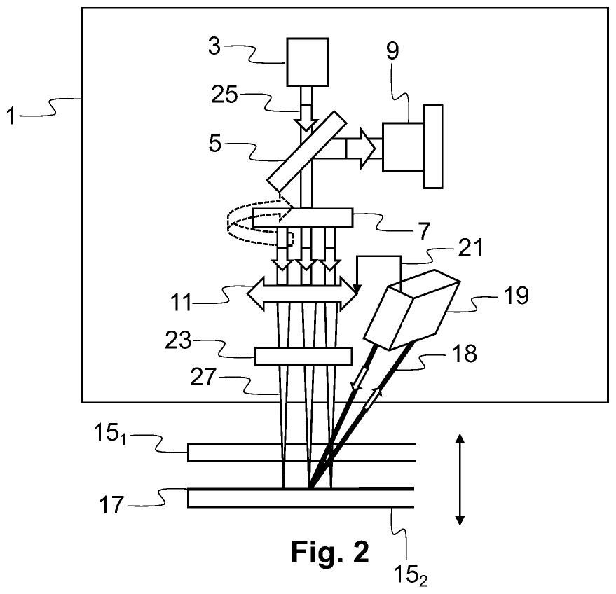

FIG. 2 schematically illustrates the laser head 1 according to the second embodiment of the present invention. The laser head according to the second embodiment is rather similar to the laser head of the first embodiment, but in the present embodiment, the second mirror is not needed. Furthermore, the distance sensor 19 is placed laterally on one side of the first optical element 11 and/or the second optical element 23. In this manner it can be placed sufficiently close to the target surface 17. The distance between the distance sensor measurement area and the treatment area (i.e., the target surface) is advantageously less than 20 mm, or more specifically less than 10 mm. Moreover, the laser source 3 is in this embodiment aligned with the processing laser beam 25 and the engraving laser beam 27.

Thus, in view of the above, the present invention proposes a laser processing head 1 allowing a real-time or substantially real-time adjustment of the focal points of the engraving beams 27, i.e., a real-time optical focus of multiple beams. The proposed solution is especially suitable for laser treatment of transparent conductive coatings in an assembled double/triple/curved, etc. glazing unit. By laser-treating the conductive coating(s) 17, a high transmittance for electromagnetic waves in the mobile communication spectrum can be achieved, while maintaining a low thermal emissivity, which is necessary for good thermal insulation by removing a small percentage of the total surface area of the coating, i.e., advantageously less than 20% or more specifically less than 5% of the total surface area. However, the teachings of the present invention may also be used for any other laser treatment, such as marking, engraving, etc. (e.g. a photovoltaic laser fired contact).

The first optical focal element 11, which may be composed of a composition of fast movable lenses or one or more tunable lenses, is controlled by using the signal from the distance sensor 19 measuring the distance from the distance sensor to the target surface 17 to be engraved. The distance measurement is performed with a fast response time, e.g. up to 200 kHz, in close vicinity of the laser treatment region, which is at least partially defined by the target surface, and which can be achieved through one or more transparent layers 15₁, 15₂, i.e. the windowpanes. The beam splitter 7, which may be a holographic/diffractive beam splitter, allows the number of processing laser beams to be multiplied to reduce the overall surface treatment time. The beam splitter 7 is advantageously rotated to follow the direction of movement of the laser head 1. This can be implemented for example so that the wavefront formed by the engraving laser beams is at an acute angle with respect to the movement direction of the laser head 1. The angle may for instance be substantially 90°. In other words, the wavefront would be substantially orthogonal to the direction of movement of the laser head 1. For this purpose, a data communication link may also be provided between the first optical focusing element 11 and the motion system so that the first optical focusing element may be rotated based on the movement information received from the motion system. Furthermore, the laser head 1 composed of the above-cited components can be rotated to follow a curved or tilted surface.

To summarise the above teachings, the present invention according to one example has the following elements or features:
A combination of one or more engraving beams 27 and a measurement beam 18 to allow the distance measurement;
High speed distance measurement in proximity of the engraving region (a few millimetres);
The optical distance sensor 19 allows the position of the interface between any two panes to be determined;
Fast response time (e.g. 1 kHz or more) of the first optical focusing element 11, which is used to position the laser spot on the chosen interface or surface, detected by the distance sensor 19;
The beam splitter 7 multiplies the incoming processing laser beam 25 to obtain e.g. 2 to 20 engraving beams 27, or even more;
The beam splitter 7 is rotary to change the axes of the engraving beams 27;
An f-theta lens 23 may be placed in the beam path to focus the different engraving beams 27 onto the same plane;
The laser head 1 can be rotated (e.g. ±45°), preferably around the processing laser beam axis, to maintain the laser head 1 perpendicular to the surface, and to treat curved or tilted surfaces;
The wavelengths used for the engraving beams 27 and the measurement beams 18 are advantageously different from each other to avoid interference (e.g. if both the engraving beams 27 and the measurement beams 18 are detected by the distance sensor 19; and
The dichroic mirror 5 can be used to place the vision system 9 in line of the engraving beams to control the process.

FIGS. 3a to 3g illustrate examples of different engraved patterns for the structured coating 17. The patterns are illustrated in the examples of FIGS. 3a to 3g in a coordinate system, where the x-axis represents the horizontal axis (with respect to the ground), and the y-axis represents an axis which is orthogonal to the x-axis and follows the surface of the coating or more specifically the surface of a coating patch 29. Thus, if the glazing unit is placed vertically, then the y-axis is a vertical axis. D1 denotes a first dimension D1, which in this example is parallel to the x-axis, while D2 denotes a second, orthogonal dimension, which in this example is parallel to the y-axis. The black regions correspond to the coating patches 29, while the white regions show trenches 31, channels, or ditches made to the respective coating by the engraving process. In this manner a laser-structured coating can be obtained, where the thermal emissivity of the coating is preferably at most approximately 20%, or more specifically at most approximately 15%. In this example, the trenches extend cross-sectionally through the coating, and thus the trenches reach the surface of the layer underneath. The trenches thus electrically separate different electrically conductive cells, patches or regions formed in the coating from each other. The ablated area (i.e., the surface area of the trenches 31) is kept small thanks to very narrow ablated lines. Furthermore, as the lines are very small, the structure is hardly seen by the naked eye in most situations. It has been discovered that good results are obtained if the patches are separated from each other by a distance in the range of 0.001 mm to 0.5 mm, and more specifically by distance in the range of 0.01 mm to 0.1 mm.

In view of the above, a length or a length projection of one or more patches 29 along a first axis is greater than a height or a height projection of the one or more patches 29 along a second, different axis, wherein the first axis substantially horizontally follows a respective patch surface or its virtual extension, and the second axis follows the respective patch surface or its virtual extension orthogonally to the first axis. The first axis may be a horizontal axis, and the second axis may be a vertical axis.

FIG. 3a shows patches 29 that have a square shape. Instead, or in addition, the patches could have other regular shapes, such as triangles or circles. As can be seen in FIGS. 3b to 3g, the patches 29 are in these examples made elongated and they thus define a longitudinal axis along which the patches 29 extend (for instance, in the example of FIG. 3b, the length axis is parallel to the x-axis). In other words, their first dimension D1 is greater than a second, orthogonal or substantially orthogonal dimension D2. In the examples of FIGS. 3b to 3g, the first dimension D1 extends along the x-axis, which in this example is a horizontal axis, while the second dimension D2 extends along the y-axis, which is orthogonal to the x-axis, and is often a vertical axis, but not always (in particular when the coating 17 is not oriented vertically but would be curved or tilted with respect to the vertical orientation). Both the x-axis and y-axis are parallel to the coated surface. The first and second dimensions may thus be understood to extend tangentially along the patch surface.

In the design of FIG. 3b, the patches 29 are rectangles, and more specifically elongated rectangles, while in the design of FIG. 3c, the patches 29 are tilted elongated rectangles or they could be rhomboids. In the design of FIG. 3d, the patches 29 are triangles, while in the design of FIG. 3e, the patches 29 are hexagons, and more specifically non-regular or elongated hexagons. In FIG. 3f, waveforms are used to create the patches 29 while in FIG. 3g, oval shapes are used to create the patches 29. More specifically, in the design of FIG. 3f, first waveforms cross second waveforms to create patches of different sizes. In the design of FIG. 3g, partially overlapping ovals are used to create patches of different sizes. It is to be noted other shapes would also or instead be possible, such as parallelograms or tilted parallelograms. The patch length/height ratio may be between 1 to 20, or more specifically between 1 and 8, or 1.5 and 8. Furthermore, at least some of the patches have a length in the range of 0.5 mm to 20 mm, and more specifically in the range of 0.5 mm to 10 mm, or in the range of 0.5 mm to 5 mm.

It is to be noted that the trajectory of the laser head is advantageously pre-programmed depending on the desired pattern shape. For example, the ditch lines that are parallel to each other can be first engraved with one or more laser head movements, and then the laser head may be reoriented, for instance by rotating it by 90 degrees (or by any desired amount) to engrave ditch lines having a different orientation.

While the invention has been illustrated and described in detail in the drawings and foregoing description, such illustration and description are to be considered illustrative or exemplary and not restrictive, the invention being not limited to the disclosed embodiments. Other embodiments and variants are understood, and can be achieved by those skilled in the art when carrying out the claimed invention, based on a study of the drawings, the disclosure and the appended claims. Further variants may be obtained by combining the teachings of any of the designs explained above.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the invention.

1. A laser engraving device for engraving a target surface, the laser engraving device comprising:
a beam splitter for dividing a processing laser beam into a plurality of engraving laser beams;
a first optical focusing element with an adjustable focal point for focusing the plurality of engraving laser beams onto the target surface; and
an optical sensor configured to determine the distance between the target surface and the optical sensor,
wherein the first optical focusing element is connected to the optical sensor by a data link to receive the determined distance from the optical sensor, and wherein the first optical focusing element is configured to adjust its focal point based on the determined distance received from the optical sensor.

2. The laser engraving device according to claim 1, wherein the optical sensor is configured to determine the distance at given measurement time intervals and/or the first optical focusing element is configured to adjust the focal point at given adjustment time intervals.

3. The laser engraving device according to claim 2, wherein the measurement time interval and/or the adjustment time interval is at most 20 μs, or more specifically at most 10 μs, or at most 3 μs.

4. The laser engraving device according to claim 1, wherein the optical sensor is configured to feed the determined distance values to the first optical focusing element via the data link.

5. The laser engraving device according to claim 1, wherein the laser engraving device further comprises a second optical focusing element placed in the path of the plurality of the engraving laser beams, and configured to focus the plurality of the engraving laser beams onto one plane.

6. The laser engraving device according to claim 1, wherein the optical sensor is an optical distance sensor or an optical displacement sensor.

7. The laser engraving device according to claim 1, wherein the laser engraving device further comprises a first mirror, and wherein the first mirror is a dichroic mirror configured to redirect the incoming processing laser beam towards the beam splitter, while allowing a reflected light from the target surface to pass through the dichroic mirror without redirecting it, or the dichroic mirror is configured to redirect the reflected laser beam from the target surface, while allowing the incoming processing laser beam to pass through the dichroic mirror without redirecting it.

8. The laser engraving device according to claim 1, wherein the laser engraving device further comprises a vision system placed on the path of a laser beam reflected from the target surface.

9. The laser engraving device according to claim 1, wherein the laser engraving device is configured to be rotated around one or more rotation axes and/or translate in one or more directions.

10. The laser engraving device according to claim 1, wherein the first optical focusing element is configured to be rotated around one or more rotation axes.

11. The laser engraving device according to claim 10, wherein the rotation direction depends on the direction of movement of the laser engraving device.

12. The laser engraving device according to claim 10, wherein the first optical focusing element is configured to be rotated so that a wavefront formed by at least some of the engraving laser beams is at an acute angle with respect to the direction of movement of the laser engraving device.

13. The laser engraving device according to claim 1, wherein the optical sensor is configured to determine the distance to the target surface through one or more intermediate surfaces placed between the optical sensor and the target surface to allow the optical focusing element to focus the plurality of engraving laser beams onto the target surface through the one or more intermediate surfaces.

14. The laser engraving device according to claim 1, wherein the optical sensor is configured to repeatedly determine the distance between the target surface and the optical sensor, wherein the first optical focusing element is configured to repeatedly receive the determined distance from the optical sensor, and wherein the first optical focusing element is configured repeatedly to adjust its focal point based on the determined distance received from the optical sensor.

15. The laser engraving device according to claim 1, wherein the number of the engraving laser beams is between 2 and 20, or more specifically between 6 and 10.

16. The laser engraving device according to claim 15, wherein the engraving laser beams are arranged in an M×N beam matrix array, where at least M or N is greater than 1, or where M and N are both greater than 1.

17. The laser engraving device according to claim 1, wherein the optical sensor is configured to generate one or more measurement beams having a first wavelength, and wherein the first wavelength is different from a second wavelength of the engraving laser beams.

18. The laser engraving device according to claim 1, wherein the laser engraving device further comprises a laser source configured to generate the processing laser beam.

19. The laser engraving device according to claim 1, wherein the laser engraving device is programmed to move along one or more trajectories to allow elongated patches to be formed on the target surface such that the elongated patches are electrically insulated from each other as result of the engraving process.

20. The laser engraving device according to claim 1, wherein the optical sensor is located within at most 20 mm, or more specifically within at most 10 mm from the target surface.

21. A laser engraving system comprising the laser engraving device according to claim 1, and further comprising a motion system configured to move the laser engraving device along one or more trajectories and/or to rotate the laser engraving device around one or more rotation axes.

22. The laser engraving system according to claim 21, wherein the laser engraving system further comprises a glazing unit comprising one or more transparent windowpanes and the target surface as part of an electrically conductive coating of the glazing unit.

23. A method of engraving a target surface by using a laser engraving device comprising:
a beam splitter for dividing a processing laser beam into a plurality of engraving laser beams;
a first optical focusing element with an adjustable focal point for focusing the plurality of engraving laser beams onto the target surface; and
an optical sensor configured to determine the distance between the target surface and the optical sensor,
wherein the first optical focusing element is connected to the optical sensor by a data link to receive the determined distance from the optical sensor, and the first optical focusing element is configured to adjust its focal point based on the determined distance received from the optical sensor, and wherein the method comprises:
generating the processing laser beam;
directing the generated processing laser beam to the beam splitter; and
moving the laser engraving device along one or more pre-programmed trajectories to allow a desired pattern to be formed on the target surface as a result of the engraving process while adjusting the focal point of the first optical focusing element based on the determined distance received from the optical sensor.
